(19) United States
(12) Patent Application Publication
(10) Pub. No.: US 2025/0207640 A1
(43) Pub. Date: Jun. 26, 2025

(54) TORSIONALLY ELASTIC COUPLING

(71) Applicant: Flender GmbH, Bocholt (DE)

(72) Inventor: Stefan Kleinewegen, Bocholt (DE)

(73) Assignee: Flender GmbH, Bocholt (DE)

(21) Appl. No.: 18/849,896

(22) PCT Filed: Mar. 9, 2023
(86) PCT No.: PCT/EP2023/055983

§ 371 Date: Sep. 23, 2024

(30) Foreign Application Priority Data
Mar. 24, 2022 (EP) 22164071.7

(51) Int. Cl. F16D 3/12; B33Y 50/00; B33Y 80/00; F16D 3/68

(52) U.S. Cl. CPC F16D 3/12; B33Y 50/00; B33Y 80/00; F16D 3/68; F16D 2250/00

(57) ABSTRACT

A torsionally elastic coupling for connecting a drive shaft to an output shaft includes a first coupling part, a second coupling part comprising axially directed drivers, and a plurality of dumbbell-shaped buffer elements. Each buffer element has two end buffers which are connected via a central region. The buffer elements are held on a circular arc of the first coupling part via the respective central region in slotted radial webs of the first coupling part, with the axially directed drivers of the second coupling part seated between adjacent ones of the buffer elements in an operating situation. A woven fabric insert forms a contact surface of the buffer elements in facing relationship to the radial webs.

The invention relates to a torsionally elastic coupling for connecting a drive shaft to an output shaft, comprising a first coupling part and a second coupling part, a plurality of dumbbell-shaped buffer elements with two end buffers connected via a central region, wherein the buffer elements are held on a circular arc of the first coupling part via the respective central region in slotted radial webs of the first coupling part, and wherein the second coupling part has axially directed drivers which are seated between buffer elements in an operating situation.

DE 1 965 000 U discloses a torsionally elastic coupling, Couplings of this kind are used in order to connect drive motors to a working machine, possibly even indirectly via a transmission, and to transmit a torque via the coupling in an installation. In these applications, unplanned but also planned stoppage of the drive motor leads to a production downtime of the installation, together with corresponding subsequent costs. During operation, the transmitted torque causes tensile stresses in the buffer elements, and these tensile stresses may lead to cracks in the material of one or more of the buffer elements. There is a need to considerably reduce or even to eliminate the tendency for cracks to form in the material of the buffer elements particularly when there is an increase in the power density of the installation.

The object of the invention is to indicate measures which allow improved durability of a coupling.

The object is achieved by a torsionally elastic coupling having the features of claim 1. Preferred refinements are specified in the dependent claims and the following description, which preferred refinements can represent one aspect of the invention in each case individually or in combination. If a feature is shown in combination with another feature, this serves only for simplified illustration of the invention and is in no way intended to mean that this feature cannot be a development of the invention without the other feature.

One embodiment relates to a torsionally elastic coupling for connecting a drive shaft to an output shaft, comprising a first coupling part and a second coupling part, a plurality of dumbbell-shaped buffer elements with two end buffers connected via a central region, wherein the buffer elements are held on a circular arc of the first coupling part via the respective central region in slotted radial webs of the first coupling part, and wherein the second coupling part has axially directed drivers which are seated between buffer elements in an operating situation, and wherein a contact surface, facing the radial webs, of the buffer elements is formed by a woven fabric insert.

The coupling parts can also be referred to as coupling halves, even if a half is not a half-share in the geometric sense. In the operating situation, the two coupling parts are able to transmit torque. Here, drive rotation for torque transmission takes place about a rotation axis which, by way of its position, describes an axial direction of the coupling. Radial directions are given starting from this axial direction. The circular arc also relates to the axial direction of the rotation axis, so that a point on the rotation axis represents the central point of the circular arc. Consequently, the radial directions lie in the circular area within the circular arc.

The buffer elements are formed in a dumbbell-shaped manner and their shape can also be referred to as an H-shape, in particular in an axial view. The buffer elements have a main direction of extent on which the central region and the end buffers lie, the end buffers extending to both sides starting from the central region. The buffer elements are arranged on the circular arc in such a way that the main direction of extent lies on the circular arc.

The slotted radial webs run in the first coupling part between a hub and a housing ring connected to the hub. The plurality of radial webs are arranged circumferentially uniformly spaced apart. The slot is located substantially centrally in the web as viewed in the radial direction. The slot can have a depth in the axial direction such that it is delimited by a radially continuous portion of the respective web.

The respective buffer element rests on the radial web by way of contact surfaces. The contact surface, which is formed by a woven fabric insert and faces the radial web, can be continuous or consist of individual portions. Provision may also be made for a buffer element to have one or more further contact surfaces which make contact with the respective radial web but are not formed by a woven fabric insert. In this case, the base material of the buffer element rests directly on the radial web. Provision is preferably made for the woven fabric insert to be largely fused with the base material of the buffer element. During operation or under the action of a load. the buffer element is simultaneously pushed through the respective slot in the radial web and pressed between the second coupling part and the wall of the radial web. The tensile stresses introduced into the buffer element as a result of this are absorbed by way of the woven fabric insert, so that the tensile stresses cannot be created in the base material of the buffer element and there is no tendency for cracks to form there. Since the woven fabric insert can absorb higher tensile stresses than the base material of the buffer element overall, it is possible to increase the power density of the torsionally elastic coupling since higher torques can be transmitted without the risk of cracks forming. The base material can consist of, for example, a nitrile rubber, abbreviation NBR. This is a material with a high elasticity and good damping capability. The however limited load-bearing ability of this material is compensated for by the provided woven fabric insert, which forms the contact surface, so that cracks in the base material can be avoided even with considerably higher pressing as a result of the higher transmitted torque.

In a preferred refinement, provision is made for the contact surface formed by the woven fabric insert to extend, starting from the central region, to the mutually facing flanks of the end buffers. This ensures that, in particular, the transition regions from the central region to the flanks of the end buffers benefit from the higher load-bearing ability of the woven fabric insert. In particular, provision is preferably made for a contact surface formed by the woven fabric insert to be arranged on either side of the central region as viewed in the radial direction. This provides even greater security against cracks forming as a result of tensile stresses during operation.

In an additionally preferred refinement, the contact surface formed by the woven fabric insert is seated in a surface recess in the buffer element, wherein the magnitude of a depth of the surface recess and of a thickness of the contact surface substantially correspond. As a result, the contact surface formed by the woven fabric insert is not applied across the base material of the buffer element compared to a conventional buffer element without a reinforcing woven fabric insert. In a specific refinement, provision may be made for the contact surface formed by the woven fabric insert to have a thickness with a magnitude of between 0.1 mm and 0.5 mm, preferably between 0.2 mm and 0.3 mm.

In an additionally preferred refinement, provision is made for the material of the woven fabric insert to have a lower elasticity than the material of the buffer element. The considerably higher load-bearing ability with respect to tensile stresses can be provided in this way.

From manufacturing respects, provision is preferably made for the material of the buffer element to consist of an elastomer or a nitrile rubber and for the material for producing the buffer element to be compressed together with the woven fabric insert in a mold under temperature. As a result, the non-application, already explained above, of the contact surface formed by the woven fabric insert across the base material, in comparison to conventional buffer elements, can be realized. In a corresponding manufacturing process, the base material and the initially separate woven fabric structures are inserted into the mold and the woven fabric structures are compressed with the base material.

The object is additionally achieved by a drive train, comprising a first shaft which is designed as a drive shaft and is coupled in a torque-transmitting manner via a coupling to a second shaft which is designed as an output shaft, wherein the coupling is designed as described. The drive means can be embodied, for example, as an electric motor. A drive power is provided by the drive means via the drive shaft. The output shaft can be coupled to a mechanical application.

The object is further achieved by an industrial application, comprising a drive unit which is connected in a torque-transmitting manner to an output unit via a coupling, wherein the coupling is designed as described. The output unit may be a mechanical application in which mechanical energy transmitted via the coupling can be used. The mechanical application is, for example, a conveyor belt, pump, crane, fan, agitator or lifting apparatus.

The underlying object is additionally achieved by a data agglomeration comprising data packets combined in a common file or distributed over various files for mapping the three-dimensional design and/or the interactions between all constituent parts of a coupling as described above, wherein the data packets are set up to carry out, with processing by a data-processing device, additive production of the constituent parts of the coupling, in particular by 3D printing by means of a 3D printer, and/or simulation of the operating behavior of the coupling. Operating behavior is to be understood to mean, for example, bending behavior, overload behavior or wear behavior of the coupling or individual components. Kinematics and/or vibration characteristics of the coupling can also be simulated. The operating behavior of the coupling can be simulated in this way in an assembled state, for example in an industrial application. The data agglomeration allows cost-effective production of prototypes and/or computer-based simulations in order to study the functioning of the coupling, to identify problems in specific cases and to find improvements.

The invention will be explained below by way of example with reference to the accompanying drawings using preferred exemplary embodiments, wherein the features shown below can each represent an aspect of the invention both individually and in combination. In the drawings:

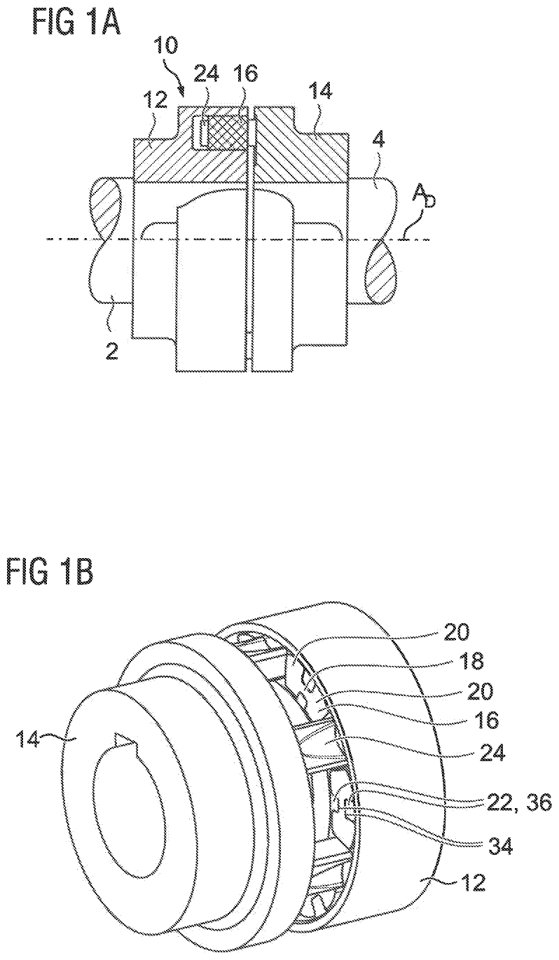

FIG. 1: shows an elastic coupling in a) a partially sectioned side view and b) a perspective view;

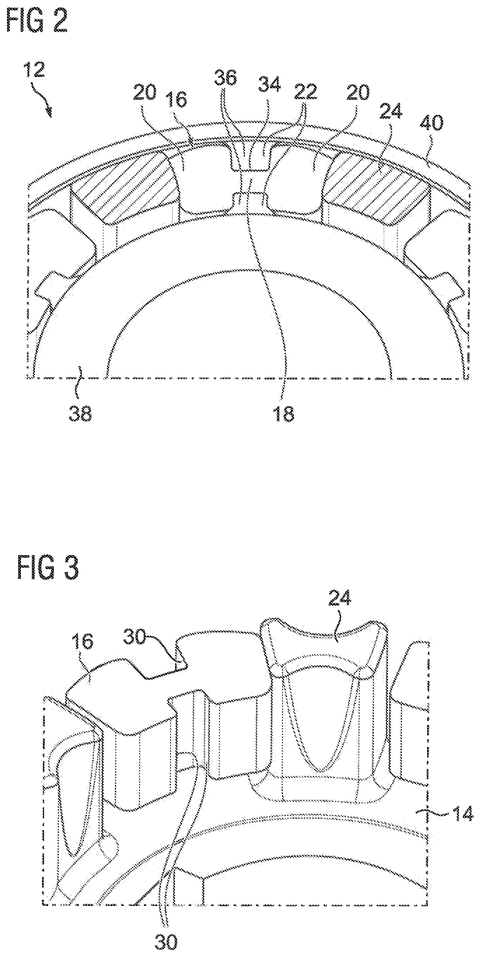

FIG. 2: shows a perspective axial section through drivers of the second coupling part of a coupling according to FIG. 1;

FIG. 3: shows a perspective axial view through the second coupling part of a coupling according to FIG. 1;

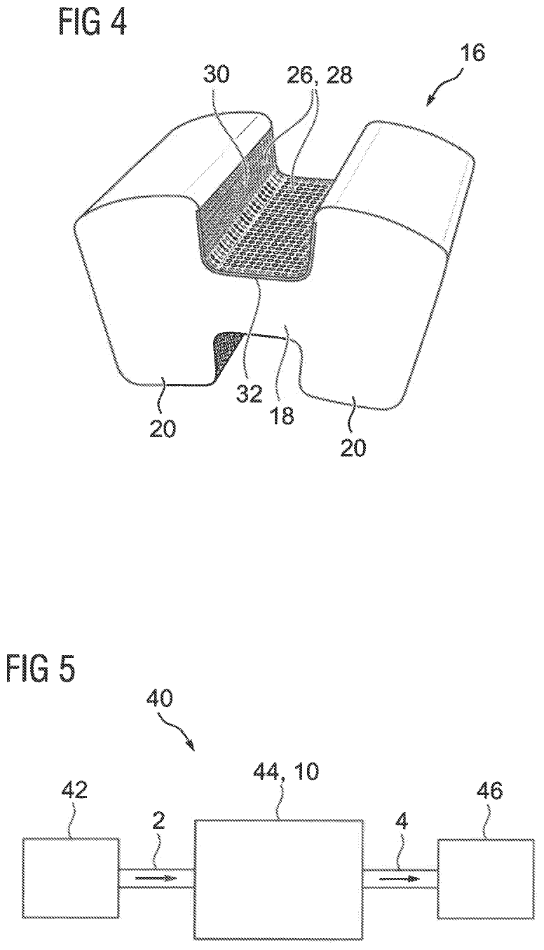

FIG. 4: shows a buffer element in the form of a detail in a perspective view, and

FIG. 5: shows a schematic illustration of an industrial application comprising a coupling.

FIG. 1 shows an elastic coupling 10; in view a) in a partially sectioned side view and in view b) in a perspective illustration. The coupling 10 consists structurally of a first coupling part 12 and a second coupling part 14 which are connected to one another in an interlocking manner in a way yet to be described for transmitting a torque. The first coupling part 12 can be drive-connected to a first shaft 2, functioning as a drive shaft, via a generally known shaft/hub connection. The second coupling part 14 can be correspondingly drive-connected to a second shaft 4 for functioning as an output shaft. The first shaft 2 can be connected to a drive motor, not illustrated. The second shaft 4 can be connected to a working machine, not Illustrated. However, in principle, a bidirectional torque flow can be provided when, for example, the drive motor is embodied as an electric machine and operated as a motor or generator depending on the respective operating state. Drive rotation for torque transmission takes place about a rotation axis A_{D} of the coupling 10. The rotation axis A_{D} describes, by way of its position, an axial direction of the coupling 10.

The first coupling part 12 has, on a circular arc around the rotation axis A_{D}, a plurality of circumferentially uniformly spaced apart slotted radial webs 22. The radial webs 22 are each formed by two web portions 36 situated on a radius and spaced apart by a slot 34. A buffer element 16 is held or clamped on each of the slotted radial webs 22. The buffer elements 16 are configured in a dumbbell-shaped manner, with two end buffers 20 and a central region 18 connecting the end buffers 20. The buffer elements 16 are held on the radial webs 22 in such a way that the central region 18 is clamped between the web portions 36 in a manner seated in the slot 34 and the end buffers 20, by way of their mutually facing flanks 30, engage around the web portions 36.

The second coupling part 14 likewise has a number of axially directed drivers 24, this number corresponding to the number of radial webs 22, on a circular arc about the rotation axis A_{D}. The drivers 24 are seated between the buffer elements 16 of the first coupling part 14 in an operating situation, in which torque can be transmitted. Torque transmission is possible via the interlocking connection between the drivers 24 seated between the buffer elements 16. FIG. 1b) shows, for reasons of illustration, a relative position of the two coupling parts 12, 14 with respect to each other, in which these two coupling parts are axially pulled apart from each other to a certain extent.

FIG. 2 shows, in the form of a detail, a perspective axial section through the drivers 24 of the second coupling part 14. Shown in particular is the dumbbell-shaped configuration of the buffer elements 16, which can also be referred to as H-shaped. Further shown is how the buffer element 16 is held or clamped on the respective slotted radial webs 22. The buffer elements 16 are held on the radial webs 22 in such a way that the central region 18 is clamped between the web portions 36 in a manner seated in the slot 34 and the end buffers 20, by way of their mutually facing flanks 30, cf. FIG. 3 in this respect, engage around the web portions 36. The slotted radial webs 22 run in the first coupling part 12 between a radially inner hub 38 and a radially outer housing 40 connected to the hub 38.

FIG. 3 shows a further detail in which the first coupling part 12 is hidden, apart from the buffer elements 16. Shown is the second coupling part 14 and a buffer element 16 circumferentially seated between the drivers 24.

FIG. 4 shows, in the form of a detail, a perspective illustration of a buffer element 16. Taking into account the above description, it is clear that a buffer element 16 rests against the respective radial web 22 via contact surfaces 26 or makes contact with the radial web 22 via the contact surfaces 26. In the case of the buffer element 16 described in the present case, contact surfaces 26, facing the radial web 22, of a buffer element 16 are formed by a woven fabric insert 28. Illustrated is an embodiment of the buffer element 16 in which a contact surface 26 formed by the woven fabric insert 28 is arranged on either side of the central region 18 as viewed in the radial direction. As an alternative however, it is also conceivable for the contact surface 26 formed by the woven fabric insert 28 to be arranged only on one side of the central region 18 as viewed in the radial direction. In addition, provision is made in the shown embodiment of the buffer element 16 for the contact surface 26 formed by the woven fabric insert 28 to extend, starting from the central region 18, onto the mutually facing flanks 30 of the end buffers 20. The contact surface 26 formed by the woven fabric insert 28 is seated in a surface recess 32 in the buffer element 16, wherein the magnitude of a depth of the surface recess 32 and of a thickness of the woven fabric insert 28 substantially correspond.

FIG. 5 shows a schematic design of an embodiment of the claimed industrial application 42 which comprises a drive unit 44 which can be designed as an electric motor, internal combustion engine or hydraulic motor. The drive unit 44 provides a drive power via a drive shaft 2, and the drive power can be transmitted to an output unit 44 via a coupling 10 and an output shaft 4. Here, the coupling 10 is designed and/or developed as described above.

### LIST OF REFERENCE SIGNS

2 Shaft
4 Shaft
10 Coupling
12 Coupling part
14 Coupling part
16 Buffer elements
18 Central region
20 End buffer
22 Radial web
24 Driver
26 Contact surface
28 Woven fabric Insert
30 Flank
32 Surface recess
34 Slot
36 Web portion
38 Hub
40 Housing ring
42 Industrial application
44 Drive unit
46 Output unit

What is claimed is:

1.-10. (canceled)

11. A torsionally elastic coupling for connecting a drive shaft to an output shaft, the torsionally elastic coupling comprising
a first coupling part;
a second coupling part comprising axially directed drivers;
a plurality of dumbbell-shaped buffer elements, each buffer element comprising two end buffers which are connected via a central region, said buffer elements being held on a circular arc of the first coupling part via the respective one of the central regions in slotted radial webs of the first coupling part, with the axially directed drivers of the second coupling part seated between adjacent ones of the buffer elements in an operating situation; and
a woven fabric insert forming a contact surface of the buffer elements in facing relationship to the radial webs.

12. The torsionally elastic coupling of claim 11, wherein the contact surface formed by the woven fabric insert extends from the central region to mutually facing flanks of the end buffers.

13. The torsionally elastic coupling of claim 11, wherein the contact surface formed by the woven fabric insert is arranged on either side of the central region as viewed in a radial direction.

14. The torsionally elastic coupling of claim 11, wherein the contact surface formed by the woven fabric insert is seated in a surface recess in the buffer element, with the surface recess having a depth which substantially corresponds to a thickness of the woven fabric insert.

15. The torsionally elastic coupling of claim 14, wherein the thickness of the woven fabric insert is between 0.1 mm and 0.5 mm.

16. The torsionally elastic coupling of claim 14, wherein the thickness of the woven fabric insert is between 0.2 mm and 0.3 mm.

17. The torsionally elastic coupling of claim 11, wherein the woven fabric insert is made of a material having an elasticity which is lower than an elasticity of a material of the buffer element.

18. The torsionally elastic coupling of claim 11, wherein the buffer element is made of an elastomer which for producing the buffer element is compressed together with the woven fabric insert in a mold at a temperature.

19. A drive train, comprising:
a first shaft designed as a drive shaft;
a second shaft designed as an output shaft; and
a coupling designed to couple the first shaft in a torque-transmitting manner to the second shaft, said coupling comprising a first coupling part connected to the first shaft, a second coupling part connected to the second shaft, and a plurality of dumbbell-shaped buffer elements, each buffer element comprising two end buffers which are connected via a central region, said buffer elements being held on a circular arc of the first coupling part via the respective one of the central regions in slotted radial webs of the first coupling part, with the second coupling part comprising axially directed drivers which are seated between adjacent ones of the buffer elements in an operating situation, the coupling further comprising a woven fabric insert forming a contact surface of the buffer elements in facing relationship to the radial webs.

20. An industrial application, comprising:
an output unit;
a drive unit; and
a coupling designed to connect the drive unit in a torque-transmitting manner to the output unit, said coupling being designed as set forth in claim 11.

21. A data agglomeration, comprising data packets combined in a common file or distributed over various files for mapping a three-dimensional design and/or interactions between all constituent parts provided in the coupling set forth in claim 11, wherein the data packets, when loaded into a data-processing device, are set up to carry out additive production of constituent parts of the coupling and/or simulation of an operating behavior of the coupling.

22. The data agglomeration of claim 21, wherein the additive production of constituent parts of the coupling is carried out by 3D printing using a 3D printer,
